(19) United States
(12) Patent Application Publication
(10) Pub. No.: US 2004/0128444 A1
(43) Pub. Date: Jul. 1, 2004

(54) Method for storing data in disk array based on block division and method for controlling input/output of disk array by using the same

(76) Inventors: Sung-Hoon Baek, Daejon (KR); Chong-Won Park, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/737,520

(22) Filed: Dec. 15, 2003

(30) Foreign Application Priority Data
Dec. 24, 2002 (KR) 2002-83443
Oct. 31, 2003 (KR) 2003-76662

(51) Int. Cl. G06F 12/00

(52) U.S. Cl. 711/114

(57) ABSTRACT

Provided are a method for storing data in a disk array based on block division and a method for controlling input/output in a disk array based on multiple command pending. The object of the present invention is to provide a method for storing data in a disk array based on block division by dividing the blocks of large amounts of data, such as video/audio data stream into split blocks and a method for controlling input/output of a disk array based on multiple command pending. The data placement method includes the steps of: a) dividing data into logical blocks based on an input/output unit of a file system; b) dividing the logical blocks into split blocks by the number of disks included in the disk array; and c) commanding to store the split blocks in the disks of the disk array sequentially.

### FIELD OF THE INVENTION

The present invention relates to a method for controlling input/output of a disk array based on multiple command pending in a data storing method based on block division in disk array; and, more particularly, to a method for controlling input/output of a disk array based on multiple command pending in a data placement method based on block division in disk array, the input/output controlling method that can divide the blocks of large amounts of data, such as video/audio data stream into split blocks, store the blocks in the disk array, and control the input/output of the disk array based on the multiple command pending.

### DESCRIPTION OF RELATED ART

Technologies for processing large amounts of data, such as video/audio data stream, include a technology for storing data in a disk, a technology for reading data from the disk, a technology for storing data in a buffer and managing the data, and a technology for transmitting data through a network. Although the Performances of microprocessors and memories for processing the large data, such as video/audio data stream, are being improved, they are still inadequate and inefficient to process the large data, such as video/audio data stream, in the conventional computer and software architecture.

In a general disk array, data is distributed over a plurality of disks in parallel to improve the throughput for general files.

For example, to improve the performance of reading and writing video/audio data stream in a disk array composed of a pair of disks, the difference in the operation speeds of the inner tracks of the disks and the outer tracks should be reduced. They can be reduced by storing blocks from the inner tracks to the outer tracks in a first disk and, to the contrary, storing blocks from the outer tracks to the inner tracks in a second disk.

To take another example, there is a method that can improve the sequential input/output performance of data, such as video/audio data stream by the method of pre-patch and write-back.

As seen from the above, the conventional methods do not make effective use of the property that large amounts of data, such as video/audio data stream, are stored sequentially. Also, they have a problem that the disk access time, which is time taken for accessing video/audio data stream in an arbitrary data block, is different according to the location of the data block and that the disk access time is long. In addition, the conventional methods have a problem that they cannot take advantage of the characteristics of a disk array, which performs reading and writing video/audio data stream in parallel.

### SUMMARY OF THE INVENTION

It is, therefore, an object of the present invention to provide a data placement method of a disk array based on block division by dividing blocks of large data, such as video/audio data stream, into sub-blocks according to the number of disks included in the disk array.

It is another object of the present invention to provide a method for controlling input/output of a disk array based on multiple command pending, the method that can minimize disk access delay time by means of multiple command pending and controlling the input/output of the disk array.

In accordance with an aspect of the present invention, there is provided a method of storing data in a disk array including a plurality of disks by using block division, including the steps of: a) dividing data into logical blocks based on an input/output unit of a file system; b) dividing the logical blocks into split blocks by the number of the disks included in the disk array; and c) commanding to store the split blocks in the disks of the disk array sequentially.

In accordance with another aspect of the present invention, there is provided a method for controlling input/output of a disk array based on multiple command pending, including the steps of: a) a disk array controlling apparatus receiving input/output commands for logical blocks and transforming the logical block input/output commands into split block input/output commands; b) the disk array controlling apparatus inserting the split block input/output commands in a request pending queue; c) the disk array controlling apparatus checking the states of command pending slots and discharging a split block input/output command stored in the request pending queue to an empty command pending slot; d) the command pending slot transmitting the split block input/output commands to the corresponding disks of the disk array; and e) removing the split block input/output command from the command pending slot when the interrupt for the split block input/output command completion occurs.

In accordance with another aspect of the present invention, there is provided a method for controlling input/output of a disk array including a plurality of disks based on multiple command pending, including the steps of: a) transmitting the first split block read command and the second split block read command to the disk of the disk array; b) completing the input/output operation of a logical block by collecting split blocks received from the disks based on the split block read commands; c) determining if there is another logical block, i.e., an (n+2)^{th} logical block, which is the next logical block of the next one of the completed n^{th} one; d) if there is another logical block, i.e., the (n+2)^{th} logical block, transmitting an (n+2)^{th} split block read command to the disks of the disk array and proceeding to the step b); and e) if there is no more logical block, checking if all the logical blocks commanded to be read are completed.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a hardware system to which the present invention is applied;

FIG. 2 is a diagram illustrating a method for storing data in a disk array based on block split in accordance with an embodiment (N=2ⁿ) of the present invention;

FIG. 3 is a flowchart describing a method for storing data in a disk array based on block split in accordance with the embodiment (N=2ⁿ) of the present invention;

FIG. 4 is a diagram illustrating a method for storing data in a disk array based on block split in accordance with another embodiment (N≠2ⁿ) of the present invention;

FIG. 5 is a flowchart describing a method for storing data in a disk array based on block split in accordance with the embodiment (N≠2ⁿ) of the present invention;

FIG. 6 is a diagram illustrating a method for controlling input/output of a disk array based on multiple command pending in accordance with an embodiment of the present invention;

FIG. 7 is a flowchart describing a method for controlling input/output of a disk array based on multiple command pending in accordance with the embodiment of the present invention;

FIG. 8 is a diagram illustrating a method for controlling input/output of a disk array based on multiple command pending in accordance with another embodiment of the present invention; and

FIG. 9 is a flowchart describing a method for controlling input/output of a disk array based on multiple command pending in accordance with the embodiment of the present invention.

### DETAILED DESCRIPTION OF THE INVENTION

Other objects and aspects of the invention will become apparent from the following description of the embodiments with reference to the accompanying drawings, which is set forth hereinafter.

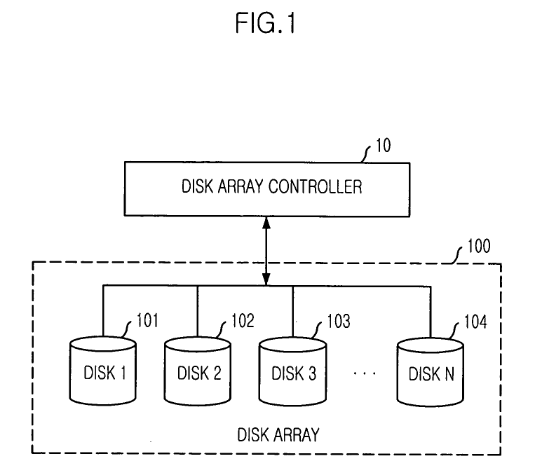

FIG. 1 is a block diagram showing a hardware system to which the present invention is applied. Referring to FIG. 1, a disk array 100 includes a plurality of disks 101 through 104, which can perform input/output. The disks 101 through 104 are connected to a disk array controller 10. The disk array controller 10 may exist independently, or may be included on a host computer. It stores files in the disks 101 to 104 of the disk array 100 and controls the input/output performances of the disks 101 through 104 of the disk array.

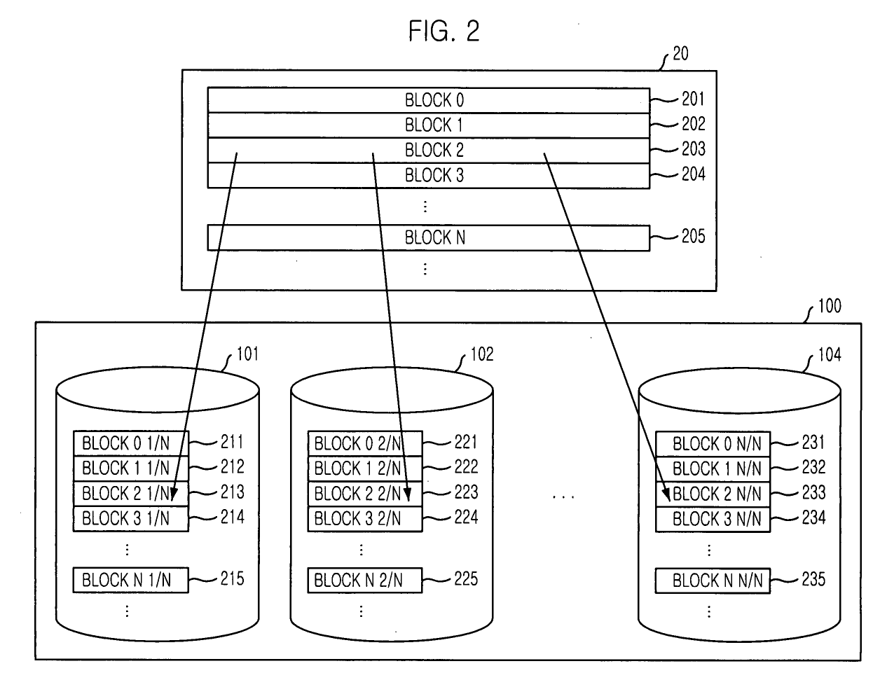

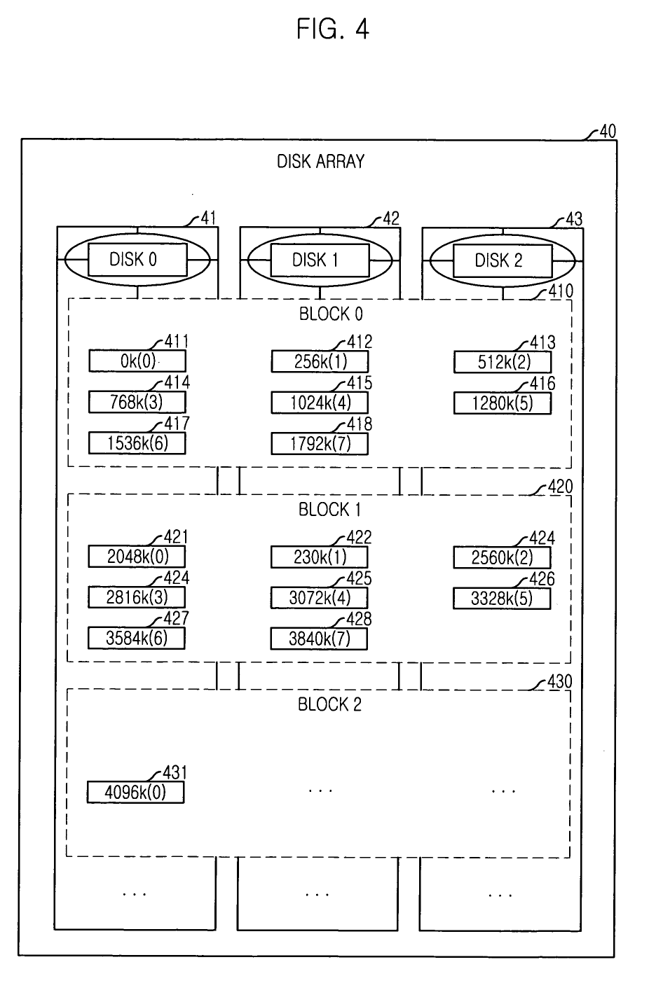

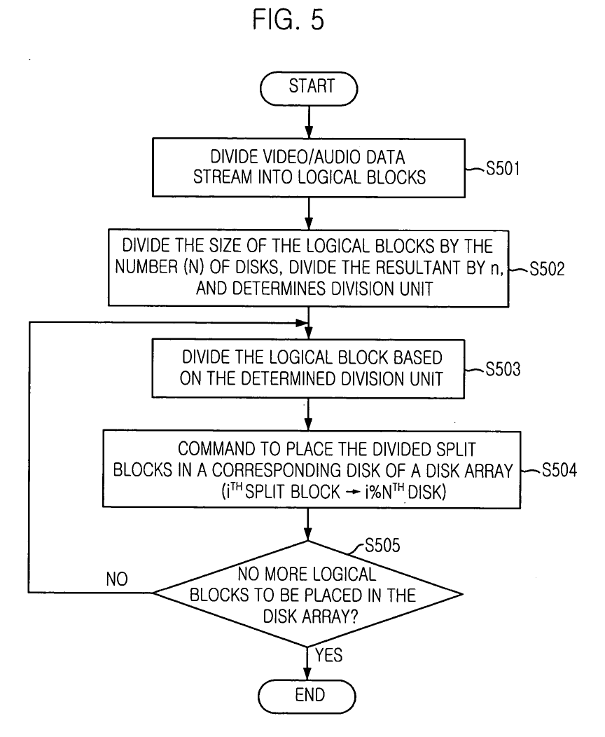

FIG. 2 is a diagram illustrating a data placement method for placing data in a disk array based on block split in accordance with an embodiment (N=2ⁿ) of the present invention. First, in the data placement method of the embodiment, it is conditioned that the number of disks is a power of 2 (N=2ⁿ). Cases that the number of disks is not a power of 2 (N#2ⁿ) will be described as another embodiment of the present invention, with reference to FIGS. 4 and 5.

Referring to FIG. 2, the reference numeral “20” indicates data divided into logical blocks based on a file system unit. The reference numeral “100” denotes a storing device having a plurality of disks, i.e., a disk array. When data are stored in the disk array 100 having a plurality of disks, logical blocks 201 to 205 divided based on the file system unit is divided equally into the number (N) of disks and then placed.

The logical blocks are placed in the order of block 0 201, block 1 202, block 2 203, block 3 204, . . . , block N 205, and each block is divided again by the number (N) of disks included in the disk array 100 so that each of the logical blocks should be equally divided and distributed in the disk array 100. A first example is the block 0 201. If the block 0 201 is divided by the number (N) of disks, N number of split blocks are obtained. Among the N split blocks, the first split block 211 of the block 0 201 is placed in a first disk 101, and the second split block 221 is placed in a second disk 102, and then an N^{th} split block 231 is placed in an N^{th} disk 104. The rest of the logical blocks are split and placed in the disk array 100 in the same manner.

Accordingly, in the first disk 101, the first split block 211 of the split blocks which are obtained by dividing the block 0 201 by N, the first split block 212 of the split blocks obtained by dividing the block 1 202 by N, the first split block 213 of the split blocks obtained by dividing the block 2 203 by N, . . . , and the first split block 215 of the split blocks obtained by dividing the block N 205 by N are placed sequentially.

In the second disk 102, the second split block 221 of the split blocks obtained by dividing the block 0 201 by N, the second split block 222 of the split blocks obtained by dividing the block 1 202 by N, the second split block 223 of the split blocks obtained by dividing the block 2 203 by N, . . . , and the second split block 225 of the split blocks obtained by dividing the block N 205 by N are placed sequentially.

To generalize the above, each of the split blocks obtained by dividing an n^{th} block by N is placed in an n^{th} block of each disk of the disk array. Accordingly, a k^{th} split block is placed in an n^{th} block of a k^{th} disk of the disk array.

Since a file is equally divided into split blocks and placed in a disk array on a split block basis, when an arbitrary block is accessed to, all the disks in the disk array are operated simultaneously.

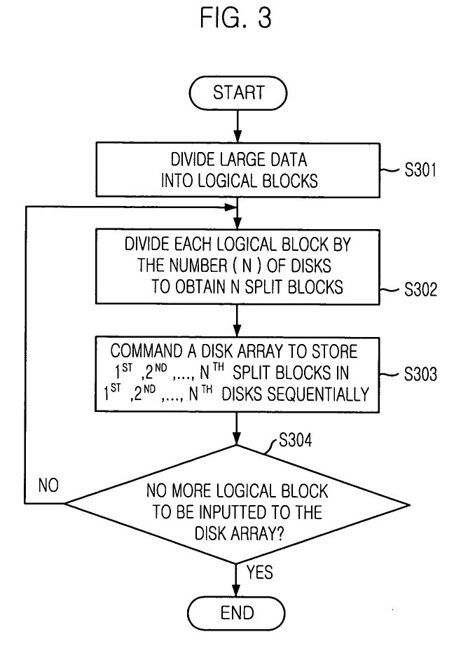

FIG. 3 is a flowchart describing a method for storing data in a disk array based on block split in accordance with the embodiment (N=2ⁿ) of the present invention.

Referring to FIG. 3, at step S301, large data are divided into logical blocks based on the input/output unit of a file system. At step S302, each of the logical blocks is divided by the number N of disks included in the disk array, thus producing N split blocks.

At step S303, the N split blocks are commanded to be stored in the disks of the disk array sequentially. That is, a first split block is stored in a first disk, and a second split block is stored in a second disk, and then an N^{th} split block is stored in an N^{th} disk.

After the process of each logical block, at step S304, it is checked whether there is any logical block not processed. If there is no logical block left, the logic flow is terminated. If there is a logical block remaining to be stored, the logic flow returns to the step S302 and repeats the subsequent processes.

Meanwhile, the above-described embodiment can hardly be applied to a case where the number of disks composing a disk array is not the power of 2 (N≠2ⁿ). This is because the size of a split block that can send a command to a disk should be 1024×2^{k}, k being an integer. If the number of disks that forms the disk array is 3, which is not the power of 2 and the size of a logical block is 1 megabyte, the size of a split block is (1024×1024) bytes÷3=349525.3 bytes. This size of the split block cannot exist.

Therefore, when the number of disks is not the power of 2 (N≠2ⁿ), a size of a logical block is divided by the number of the disks, and the resultant value is divided by n again, where n is a natural number. Then, a value of 1024×2^{k} is selected among the values that are equal to or larger than the resultant value, and the logical block is divided by the value of 1024×2^{k} and placed in the disk, where k is a positive integer including zero. More details will be described with reference to FIGS. 4 and 5.

FIG. 4 is a diagram illustrating a method for storing data in a disk array based on block split in accordance with another embodiment (N≠2ⁿ) of the present invention. First, described hereafter is the data storing method based on block division, when the number of disks is not the power of 2 (N≠2ⁿ). The size of a logical block is divided by the number of the disks included in the disk array, and the resultant value is divided by a predetermined divisional variable (n). Then, a value of 1024×2^{k} is selected among the values that are equal to or larger than the resultant value. The logical block is divided by the selected value and stored in the disk. Here, k is a positive number and n is a natural number. The predetermined divisional variable (n) is a value determined to distribute split blocks effectively. The larger the divisional variable (n) is, the smaller the size of a split block becomes. So, it is desirable to select a value as small as possible. In a case to be described below, the number of disks is 3 (N=3) and the predetermined divisional variable is 3 (n=3), and the size of a logical block is 2048 kB.

Referring to FIG. 4, logical blocks 410 to 430 are placed in disks 41 to 43, sequentially. Each logical block 410, 420 or 430 is divided into split blocks 411 to 418, 421 to 428, and 429, and then stored in the disks 41 to 43.

Here, the size of the split blocks 411 to 418, 421 to 428, and 429 is determined as 256 kB, a value that satisfies 1024×2^{k} among the values that are equal to or larger than 227 kB. 256 kB is a value obtained by dividing the size of the logical blocks 410, 420 and 430 by the number of the disks (N=3) and dividing the resultant value again by n (n=3). The logical blocks 410, 420 and 430 are divided into split blocks of the selected size and placed in the disks 41 to 43 sequentially.

That is, in the first logical block 410, the first split block 411, the fourth split block 414 and the seventh split block 417 are stored in the first disk 41. The second split block 412, the fifth split block 415 and the eighth split block 418 are placed in the second disk 42. The third split block 413 and the sixth split block 416 are placed in the third disk 43.

Likewise, in the second logical block 420, the first split block 421, the fourth split block 424, and the seventh split block 427 are placed in the first disk 41. The second split block 422, the fifth split block 425 and the eighth split block 428 are placed in the second disk 42. The third split block 423 and the sixth split block 426 are placed in the third disk 43. The other logical blocks 430 are placed in the same method.

FIG. 5 is a flowchart describing a method for storing data in a disk array based on block split in accordance with the embodiment (N≠2ⁿ) of the present invention. First, at step S501, video/audio data stream are divided into logical blocks according to the input/output unit of a file system.

At step S502, a value that satisfies 1024×2^{k} bytes is selected as a division unit, among the values that are equal to or larger than a value obtained by dividing the size of a logical block by the number of disk and dividing the resultant value again by a predetermined divisional variable (n). At step S503, a logical block is divided into split blocks based on the selected division unit.

At step S504, the split blocks are commanded to be stored in corresponding disks of a disk array. That is, it is commanded to store a first split block in a first disk; a second split block, in a second disk; and an i^{th} split block, in an i % N disk. Here, N is the number of disks and % denotes a modulus operator.

Subsequently, at step S505, it is determined if there is any logical block left out of storing after processing one logical block finishes. If there is no logical block left, the logic flow is ended. If there is a logical block to be stored, the logic flow goes to the step S503 and processes the remaining logical block in the same process as described above.

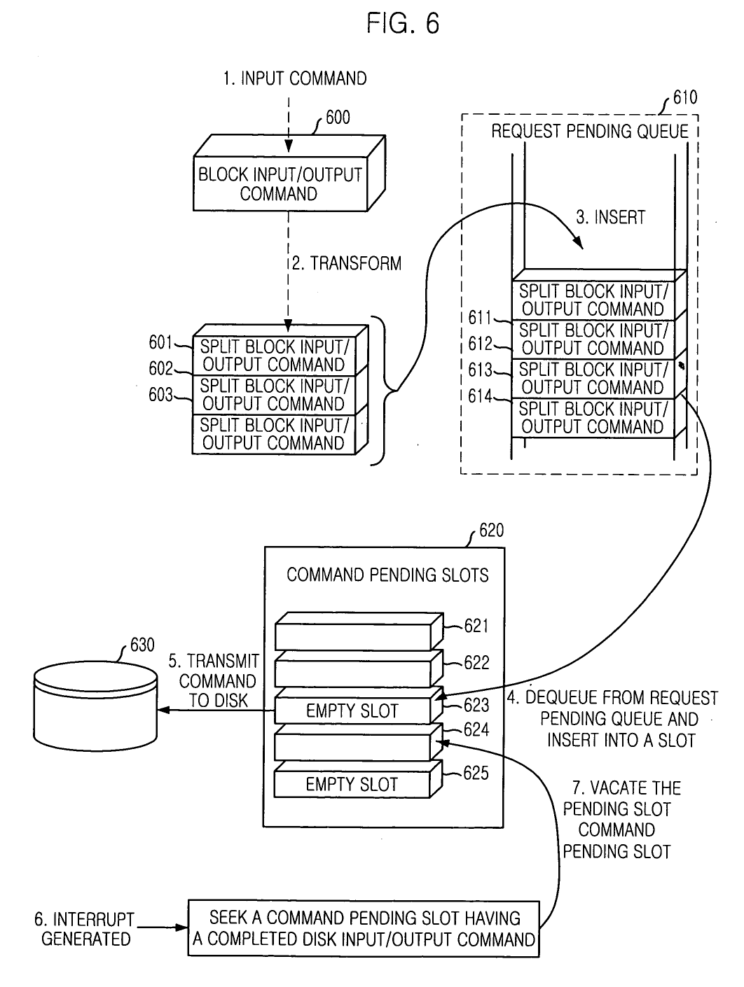

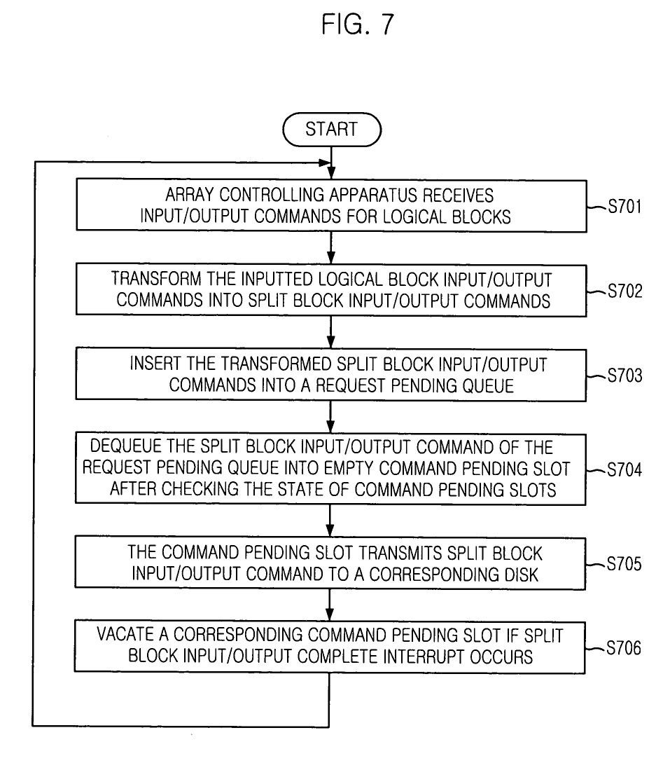

FIG. 6 is a diagram illustrating a method for controlling input/output of a disk array based on multiple command pending in accordance with an embodiment of the present invention. FIG. 7 is a flowchart describing a method for controlling input/output of a disk array based on multiple command pending in accordance with the embodiment of the present invention.

First, at step S701, a disk array controlling apparatus 10 receives an input/output command 600 for logical blocks 201 to 205. At step S702, the logical block input/output command 600 is transformed into split block input/output commands 601 to 603 for disks 101 to 104 of a disk array.

For example, if the disk array controlling apparatus 10 receives receive an input/output command for a second logical block 202, the received logical block input/output command is transformed into split block input/output commands for inputting/outputting corresponding split blocks 212, 222 and 232 that are stored in the disks 101 to 104 of the disk array.

Subsequently, at step S703, the disk array controlling apparatus 10 inserts the split block input/output commands 601 to 603 into a request pending queue 610. The request pending queue 610 is a data structure that receives and stores the split block input/output commands 611 to 614 sequentially and dequeues them in the order they are queued.

At step S704, the disk array controlling apparatus 10 checks the states of command pending slots 621 to 625 and, if there are empty command pending slots 623 and 625, it dequeues the split block input/output commands, which are stored in the command pending queue 610 to the command pending slots 623 and 625 in the order of the oldest to the newest.

The command pending slots 620, 621 and 625 are data storing space for storing one or more split block input/output commands. At first, they are in the state of not containing any split block input/output command, that is, they are vacant. Then, when the disk array controlling apparatus 10 receives a logical block input/output command, it dequeues split block input/output commands which are obtained by transforming the logical block input/output command into vacant command pending slots through a request pending queue.

Meanwhile, at step S705, the command pending slot 620 transmits the split block input/output commands dequeued from the request pending queue 610 to the disks of the disk array. The number of command pending slots 620, 621 and 625 can be adjusted to optimize the input/output performance. Also, the number of split block input/output commands to be stored in one command pending slot 621, 622, 623, 624 or 625 can be controlled suitably for the input/output performance.

Subsequently, at step S706, if the disks 101 to 104 complete the input/output command for the split blocks transmitted from the command pending slot 620 and thus interrupt occurs, the disk array controlling apparatus 10 removes the completed disk input/output command from the corresponding command pending slot.

Meanwhile, after the split block input/output commands that are pending in the command pending slot 620 are processed, the process is ended. If the disk array controlling apparatus 10 receives input/output commands for another logical block, the processes of the steps S702 to S706 are repeated.

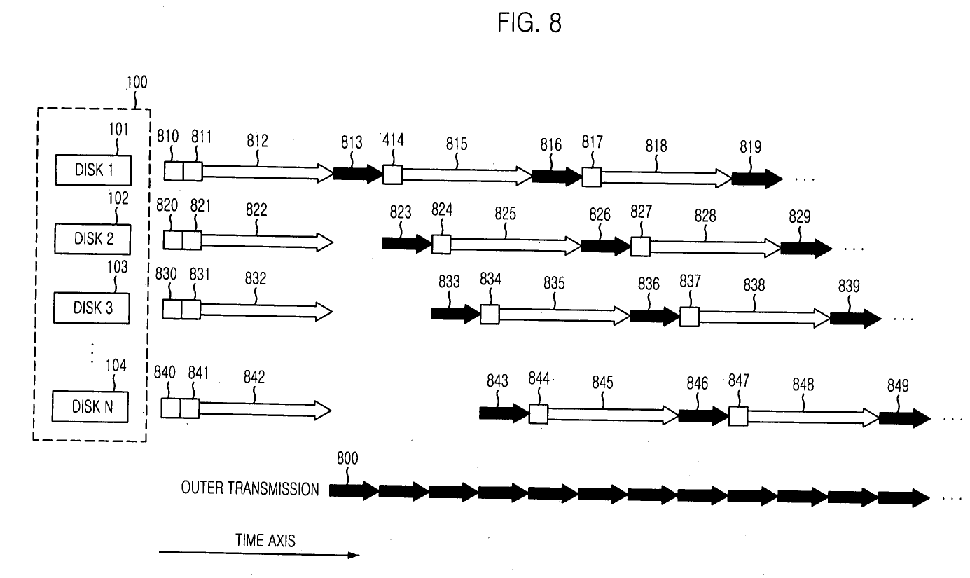

FIG. 8 is a diagram illustrating a method for controlling input/output of a disk array based on multiple command pending in accordance with another embodiment of the present invention.

Referring to FIG. 8, when the disk array 100 storing the video/audio data stream is in an idle state and a read command is generated, first split block read commands 810, 820, 830 and 840 and second split block read commands 811, 821, 831 and 841 are transmitted to each of the disks 101 through 104 of the disk array 100 sequentially.

The disks 101 through 104 of the disk array 100 receive the split block read commands and move their heads to the location of the first split blocks, read data and perform internal transfer (812, 822, 832 and 842). Then, they transmit the first split blocks in correspondence with the split block read commands to the disk array controller 10 (813, 823, 833 and 843), externally. Here, the split blocks of the disks 101 through 104 need not be transmitted sequentially. The disk array controller 10 collects the transmitted N split blocks and forms one complete logical block, which is an allocation unit of the file system.

Upon the end of the first external transmission 413 of the first disk 101, a third split block read command 814 is issued to the first disk 101. Likewise, as soon as the second disk 102 finishes a first external transmission (823), a third split block read command 824 is issued to the second disk 102.

That is, if an arbitrary disk finishes reading an n^{th} split block, an n+2^{th} split block read command is issued instantly. Then, the disk that has received the n+2^{th} split block read command performs the internal and external transfer, which is described above.

The disk array controller 10 queues and transmits split block read commands to the disk array 100 and, as shown in FIG. 8, when all the external transmission are put on a time axis 800, the result shows that the external transmission has occurred ceaselessly. This signifies that the disk array reading method can provide highly efficient performance.

Split block read commands are generated successively, and the disk array 100 is operated in parallel. Therefore, video/audio data stream are read without delay caused by disk access time (or seek time), which requires relatively long time.

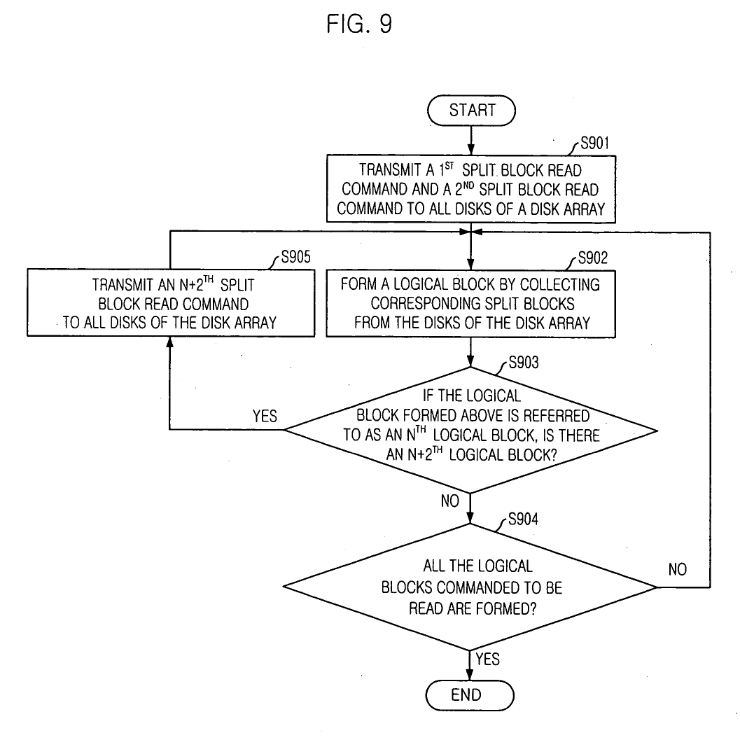

FIG. 9 is a flowchart describing a method for controlling input/output of a disk array based on multiple command pending in accordance with the embodiment of the present invention. First, at step S901, a first split block read command and a second split block read command are transmitted to all the disks of a disk array.

At step S902, split blocks transmitted from the respective disks of the disk array which has received the split block read commands are collected to complete one logical block.

When the completed logical block is referred to as an n^{th} logical block, at step S903, it is determined whether there is an n+2^{th} logical block or not. If there is, at step S905, an n+2^{th} split block read command is issued with respect to all disks of the disk array. Subsequently, the process is repeated from the step S902. If there is not the n+2^{th} logical block, at step S904, it is determined whether all logical blocks that are given read commands are completed.

If all logical blocks are read, the process is terminated. If there is an unread logical block, the logic flow returns to the step S902 and repeats the subsequent process.

The method of the present invention can be embodied as a program and stored in a computer-readable recording medium, such as CD-ROMs, RAMs, ROMs, floppy disks, hard disks, and magneto-optical disks. Since this process can be embodied by those skilled in the art easily, no further description will be provided on it.

The disk array data placement method of the present invention can operate reduce latency time by using a disk array controlling apparatus that divides and allocates large amounts of data, such as video/audio stream data, by the number of disks included in a disk array, and thus operating the disks of the disk array in parallel.

The present invention provides the disk array input/output controlling method using multiple command pending to input/output large data, such as video/audio stream data. Since input/output commands are generate continuously in the disk array and the disk array is operated in parallel, it is possible to input/output video/audio data stream without delay, which is caused by relatively long disk access time.

While the present invention has been described with respect to certain preferred embodiments, it will be apparent to those skilled in the art that various changes and modifications may be made without departing from the scope of the invention as defined in the following claims.

What is claimed is:

1. A method for storing data in a disk array including a plurality of disks by using block division, comprising the steps of:
a) dividing data into logical blocks based on an input/output unit of a file system;
b) dividing the logical blocks into split blocks by the number of disks included in the disk array; and
c) commanding to store the split blocks in the disks of the disk array sequentially.

2. The method as recited in claim 1, wherein each of the logical blocks, which are obtained at the step a), is divided by the number of the disks included in the disk array to obtain split blocks, each having the same size, at the step b).

3. The method as recited in claim 2, wherein, at the step c), the split blocks of an equal size, which are obtained at the step b), are stored in the disks of the disk array corresponding thereto sequentially, in such a way that an n^{th} block is commanded to be stored in an n^{th} disk of the disk array, satisfying a condition of N≧n≧1, N and n being integers and N denoting the number of the disks in the disk array.

4. The method as recited in claim 1, wherein, at the step b), the first value satisfying a condition of 1024×2^{k} is selected as a division unit among values that are equal to or larger than the second value which is obtained by dividing the size of the logical blocks by the number (N) of the disks in the disk array and dividing the first value by n, and the logical blocks are divided into split blocks based on the selected division unit, n and k being natural numbers.

5. The method as recited in claim 4, wherein, at the step c), the split blocks obtained at the step b) are commanded to be stored in the disks of the disk array corresponding thereto sequentially in such a way that an i^{th} split block is commanded to be stored in an i % N^{th} disk, N being the number of disks and % denoting a modulus operator.

6. A method for controlling input/output of a disk array based on multiple command pending, comprising the steps of:
a) a disk array controlling apparatus receiving input/output commands for logical blocks and transforming the logical block input/output commands into split block input/output commands;
b) the disk array controlling apparatus inserting the split block input/output commands in a request pending queue;
c) the disk array controlling apparatus checking the states of command pending slots and dequeueing the split block input/output commands from the request pending queue to empty command pending slots;
d) the command pending slots transmitting the split block input/output commands to the corresponding disks of the disk array; and
e) removing the split block input/output commands from the command pending slots, as split block input/output command completion interrupt occurs.

7. The method as recited in claim 6, further comprising the steps of:
f) dividing data into logical blocks based on an input/output unit of a file system;
g) dividing the logical blocks into split blocks based on the number of disks included in the disk array; and
h) commanding to store the split blocks in the corresponding disks of the disk array sequentially.

8. The method as recited in claim 7, wherein, at the step g), the logical blocks obtained at the step f) are divided by the number (N) of disks in the disk array to thereby obtain split blocks of an equal size; and, at the step h), the split blocks, each having the same size, are commanded to be stored in the corresponding disks of the disk array sequentially in such a way that an n^{th} split block is commanded to be stored in an n^{th} disk, satisfying a condition of N≧n≧1, N and n being integers and N denoting the number of the disks in the disk array).

9. The method as recited in claim 7, wherein, at the step g), a first value satisfying a condition of 1024×2^{k} is selected as a division unit among values that are equal to or larger than a second value which is obtained by dividing the size of the logical blocks by the number (N) of the disks in the disk array and dividing the resultant value by n, and the logical blocks are divided into split blocks based on the selected division unit, n and k being natural numbers; and, at the step h), the split blocks obtained at the step g) are commanded to be stored in the disks of the disk array corresponding thereto sequentially in such a way that an i^{th} split block is commanded to be stored in an i % N^{th} disk, N being the number of disks and % denoting a modulus operator.

10. A method for controlling input/output of a disk array including a plurality of disks based on multiple command pending, comprising the steps of:
a) transmitting a first split block read command and a second split block read command to the disk of the disk array;
b) collecting split blocks transmitted from the disks based on the split block read commands to thereby complete a logical block;
c) determining if there is another logical block, i.e., an (n+2)^{th} logical block, after the completed logical block, an nth logical block;
d) if there is another logical block, i.e., the (n+2)^{th} logical block, transmitting an (n+2)^{th} split block read command to the disks of the disk array and proceeding to the step b); and
e) if there is no more logical block, checking if all the logical blocks commanded to be read are completed.

11. The method as recited in claim 10, further comprising the steps of:
f) dividing data into logical blocks based on an input/output unit of a file system;
g) dividing the logical blocks into split blocks based on the number of disks included in the disk array; and
h) commanding to store the split blocks in the corresponding disks of the disk array sequentially.

12. The method as recited in claim 11, wherein, at the step g), the logical blocks obtained at the step f) are divided by the number (N) of disks in the disk array to thereby obtain split blocks of an equal size; and, at the step h), the split blocks of an equal size are commanded to be stored in the corresponding disks of the disk array sequentially in such a way that an n^{th} split block is commanded to be stored in an n^{th} disk, satisfying a condition of N≧n≧1, N and n being integers and N denoting the number of the disks in the disk array.

13. The method as recited in claim 11, wherein, at the step g), a first value satisfying a condition of 1024×2^{k} is selected as a division unit among values that are equal to or larger than the second value which is obtained by dividing the size of the logical blocks by the number (N) of the disks in the disk array and dividing the first value by n, and the logical blocks are divided into split blocks based on the selected division unit, n and k being natural numbers; and, at the step h), the split blocks obtained at the step g) are commanded to be stored in the disks of the disk array corresponding thereto sequentially in such a way that an i^{th} split block is commanded to be stored in an i % N^{th} disk, N being the number of disks and % denoting a modulus operator.
